(19) United States
(12) Patent Application Publication
(10) Pub. No.: US 2013/0132878 A1
(43) Pub. Date: May 23, 2013

(54) TOUCH ENABLED DEVICE DROP ZONE

(71) Applicant: REMON TIJSSEN, Mill Valley, CA (US)

(72) Inventor: REMON TIJSSEN, Mill Valley, CA (US)

(73) Assignee: ADOBE SYSTEMS INCORPORATED, San Jose, CA (US)

(21) Appl. No.: 13/225,203

(22) Filed: Sep. 2, 2011

(51) Int. Cl. G06F 3/048

(52) U.S. Cl. 715/770; 715/769

(57) ABSTRACT

A touch enabled device includes a touch enabled graphical user interface that displays a canvas region and a drop zone region. The canvas region displays an object. The drop zone region displays an area that is distinct from the canvas region. Further, the touch enabled device includes a processor that positions the object within the drop zone upon receiving a request to move the object from the canvas to the drop zone and a batch processing command that the processor performs on the drop zone region such that the batch processing command is performed on the object within the drop zone and any other objects within the drop zone region.

### BACKGROUND

1. Field

This disclosure generally relates to computing devices. More particularly, the disclosure relates to managing functionality for a touch enabled device.

2. General Background

Conventional computing devices allow for various functions, e.g., cut, copy, paste, etc., to be performed with various commands. For example, a user may press a combination of keyboard keys such as “Ctrl” and “X” to perform a cut operation. As another example, a user may perform a right click with a mouse device to select a cut operation.

Recent developments have led to an increase in demand for tablet devices. Many tablet devices are touch enabled, which allows a user to perform a variety of operations by touching a screen of a tablet device with one or more fingers, a stylus, etc. However, many tablet devices do not provide an effective approach for users to perform operations that would typically be performed on a conventional computing device, such as cut, copy, paste, etc.

### SUMMARY

In one aspect of the disclosure, a touch enabled device is provided. The touch enabled device includes a touch enabled graphical user interface that displays a canvas region and a drop zone region. The canvas region displays an object. The drop zone region displays an area that is distinct from the canvas region. Further, the touch enabled device includes a processor that positions the object within the drop zone upon receiving a request to move the object from the canvas to the drop zone and a batch processing command that the processor performs on the drop zone region such that the batch processing command is performed on the object within the drop zone and any other objects within the drop zone region.

In another aspect of the disclosure, a computer program product is provided. The computer program product includes a computer useable medium having a computer readable program. The computer readable program when executed on a computer causes the computer to display, with a touch enabled graphical user interface, a canvas region and a drop zone region. The canvas region displays an object. The drop zone region displays an area that is distinct from the canvas region. The drop zone region displays the object and any other objects within the drop zone region irrespective of the canvas region displaying a first set of content and subsequently displaying a second set of content that is distinct from the first set of content. Further, the computer readable program when executed on the computer causes the computer to position, with a processor, the object within the drop zone upon receiving a request to move the object from the canvas to the drop zone and a command that the processor performs on the drop zone region such that the batch processing command is performed on the object within the drop zone and the any other objects within the drop zone region.

In yet another embodiment of the disclosure, a process is provided. The process displays, with a touch enabled graphical user interface, a canvas region and a drop zone region. The canvas region displays an object. The drop zone region displays an area that is distinct from the canvas region and a plurality of drop zone sub-regions that each has an associated operation. Further, the process positions, with a processor, the object within the drop zone upon receiving a request and a command that the processor performs on the object within one of the plurality of drop zone sub-regions in the drop zone region upon receiving a request. In addition, the process performs the associated operation on the object based on the one of the plurality of drop zone sub-regions.

### DRAWINGS

The above-mentioned features of the present disclosure will become more apparent with reference to the following description taken in conjunction with the accompanying drawings wherein like reference numerals denote like elements and in which:

FIG. 1 illustrates a touch enabled device 100 that has a touch enabled device graphical user interface (“GUI”).

FIGS. 2A-2E illustrate an example of a first object and a second object displayed in the canvas region such that the sub-regions of the drop zone region each has an associated functionality.

FIG. 2A illustrates a movement of the first object to the first sub-region.

FIG. 2B illustrates the first object positioned in the first sub-region and cut from the canvas region.

FIG. 2C illustrates a movement of the second object to the second sub-region.

FIG. 2D illustrates the second object being deleted from both the canvas region and the drop zone region.

FIG. 2E illustrates an example of the first object and the second object being merged.

FIGS. 3A and 3B illustrate an example of a first object and a second object such that the sub-regions of the drop zone region do not each have an associated functionality.

FIG. 3A illustrates an example of the first object being positioned in the first sub-region and the second object being positioned in the second sub-region.

FIG. 3B illustrates an example of a drop zone menu that may be utilized to perform an operation on the contents of the drop zone or a portion of the contents of the drop zone.

FIG. 4A illustrates a process 400 that provides a drop zone region with batch processing.

FIG. 4B illustrates a process 450 that is utilized to provide sub-region functionality in a drop zone.

FIG. 5 illustrates a system configuration that may be utilized to provide a drop zone region.

### DETAILED DESCRIPTION

A portion of a touch enabled device graphical user interface (“GUI”) is dedicated to allowing a user to perform certain functionality. This portion is referred to herein is a drop zone region. The user may move an object to the drop zone region to perform various functions. For example, the user may drag and drop an object to the drop zone region to perform a cut, copy, paste, delete, share, or like operation on the object. In one embodiment, a user may drag a plurality of objects to the drop zone and then perform batch processing on the plurality of objects. For example, if a cut operation is to be performed on a group of objects, the user may drag all of the objects to the drop zone and then provide a single cut command to cut all of the objects in the drop zone rather than having to perform the cut operation on each individual object. In an alternative embodiment, a user may drag an object to a particular sub-region of the drop zone to perform function. For example, a tile in the drop zone may be a cut operation. The user may drag an object to that tile to perform the cut operation. The touch enabled device may be any computing device such as a tablet device, smart phone, personal computer (“PC”), laptop, or the like that allows a user to perform operations in the touch enabled device GUI by touching the GUI with one or more fingers, a stylus, or the like. The object may be a media object, a text object, a video object, an audio object, a graphics object, an interactive object, or the like.

The configurations provided for herein allow a user to easily interact with a touch enabled device to perform various functions. The user can quickly and intuitively perform various actions utilizing a variety of different touch enabled applications. In one embodiment, the drop zone region is global, i.e., provides for batch processing, which allows for operations to be performed across files without specific buttons for such operations. The drop zone may be revealed by a specific gesture, e.g., drawing a circle, or may be context, e.g., may open up when a program in the canvas region needs the drop zone to be revealed.

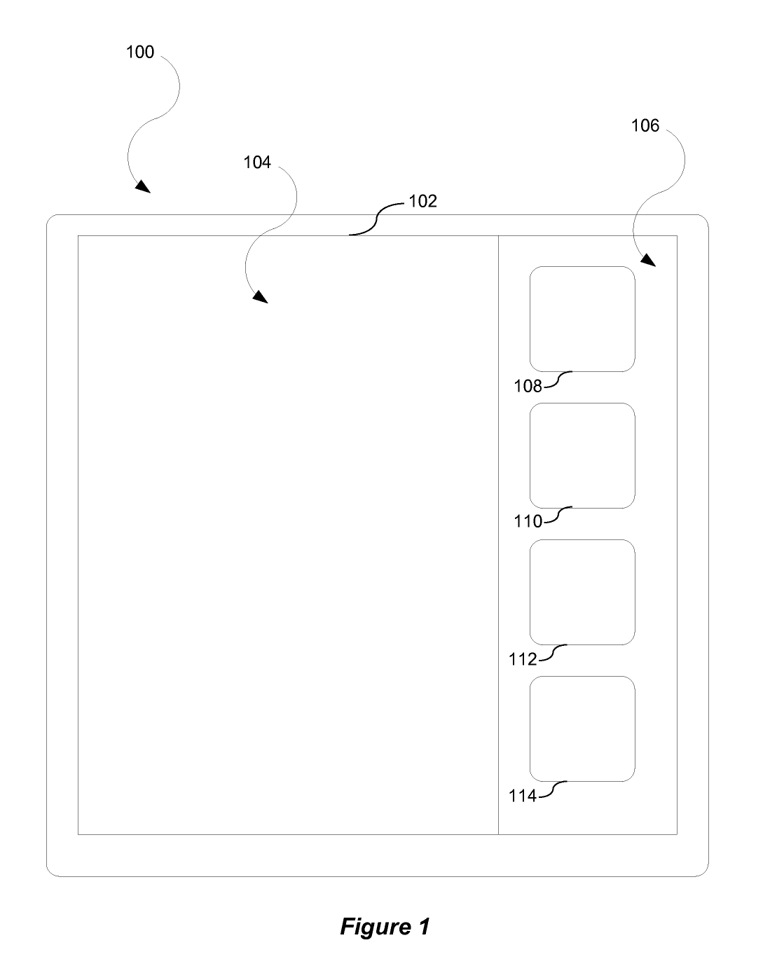

FIG. 1 illustrates a touch enabled device 100 that has a touch enabled device GUI 102. The touch enabled device GUI 102 has a canvas region 104 and a drop zone region 106. The canvas region 104 may be utilized by the user to run applications on the touch enabled device 100. For example, the user may run a drawing program, graphics program, word processing program, spreadsheet program, presentation program, web browser program, or the like in the canvas region 104.

In one embodiment, the drop zone region 106 has a plurality of sub-regions to which the user may move an object. For example, the user may move an object for placement at a first sub-region 108, a second sub-region 110, a third sub-region 112, or a fourth sub-region 114. The various sub-regions may be in the form of various shapes such as tiles, squares, circles, ellipses, or any other shape. Further, the various sub-regions may have the same shape or different shapes.

Further, in one embodiment, the sub-regions do not differ in functionality. For example, a user may position a first object in the first sub-region 108 and a second object in the second sub-region 110. Any action performed on the drop zone region 106 is then applied to all of the objects within the drop zone region 106. For example, a user may provide an input requesting a cut operation to be performed on the drop zone region 106. The cut operation is then performed on the first object and the second object. In another embodiment, the user may customize the drop zone so that the drop zone is subdivided to allow for an operation to be performed on a particular set of sub-regions.

In another embodiment, the sub-regions differ in functionality. For example, the first sub-region 108 may be associated with a particular function such as a cut operation, the second sub-region 110 may be associated with a particular function such as a copy operation, the third sub-region 112 may be associated with a particular function such as a paste operation, and a fourth sub-region 114 may be associated with a particular function such as a delete operation. Accordingly, a user's positioning of a first object in the first sub-region 108 results in a cut operation being performed on the first object. Further, the user's positioning of a second object in the second sub-region 110 results in a copy operation being performed.

In yet another embodiment, one or more sub-regions may be utilized to compose different objects into a single object. As an example, a user's positioning of a first object in the first sub-region 108 followed by a second object over the first objection in the first sub-region results in a composition of the first object and the second object. As an example, if the first object is an image and the second object is an image, such superimposition may result in a single image that combines the two images. As another example, if the first object is a document and the second object is a document, such superimposition may result in a single document in which the text of the first document and the text of the second document are merged. As yet another example, if the first object is a document and the second object is an image, such superimposition results in a single document with the text and the image.

In another embodiment, the user may create one or more sub-regions. For example, the user may drag and drop an object in an empty region of the drop zone region 106 to create a new sub-region. For example, a user could drag an object utilizing a special gesture to open a new sub-region, or some context may open a sub-region, e.g., a sub-region only opens if a program is at a certain state.

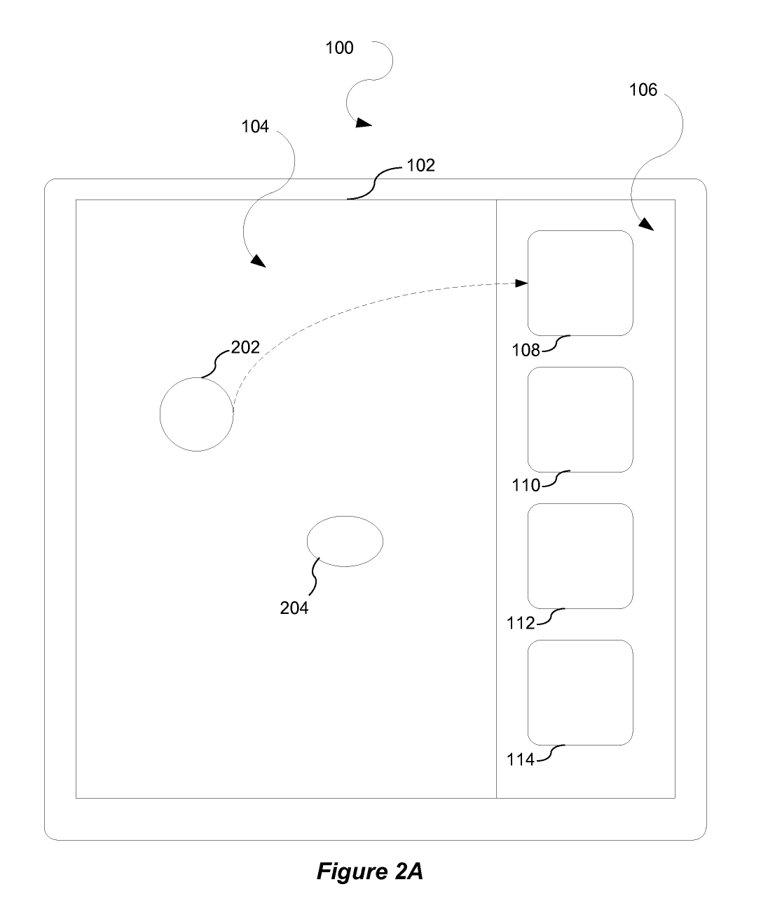

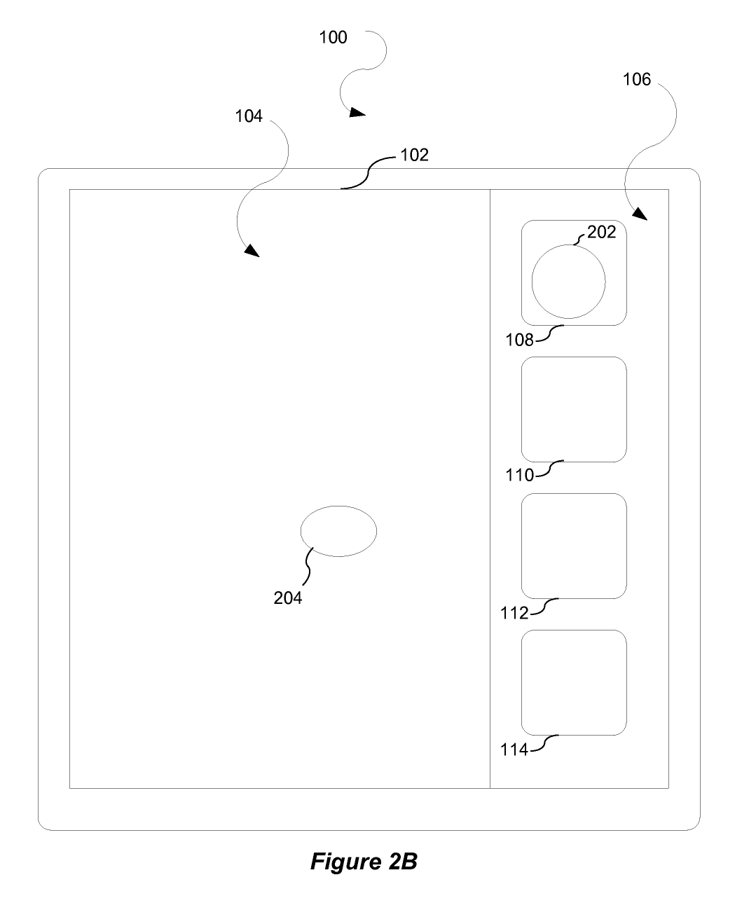

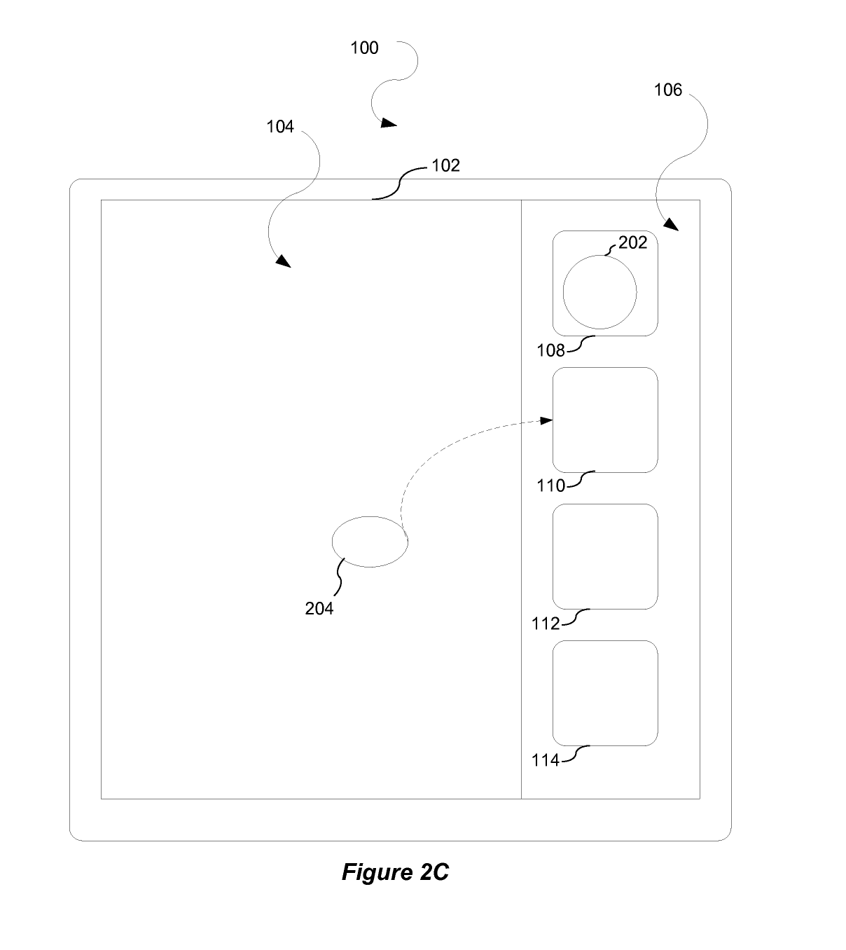

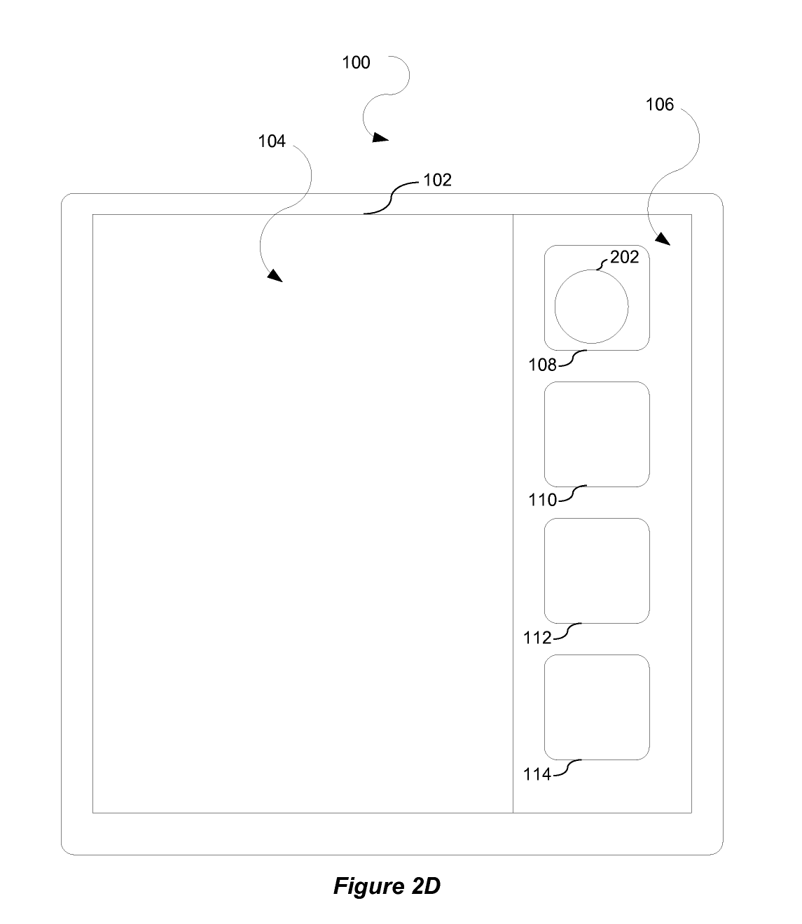

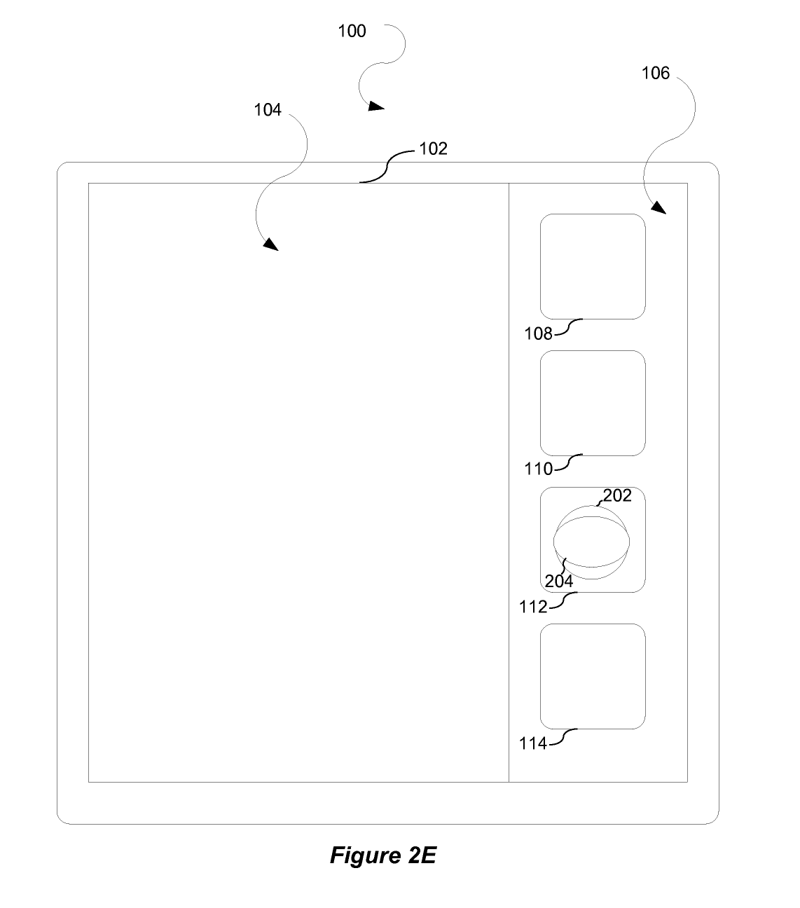

FIG. 2A-2E illustrate an example of a first object 202 and a second object 204 displayed in the canvas region 104 such that the sub-regions of the drop zone region 106 each has an associated functionality. FIG. 2A illustrates a movement of the first object 202 to the first sub-region 108. For instance, the first object 202 may be an image of a circle and the second object 204 may be an image of an ellipse. As an example, the first sub-region 108 may indicate a cut operation. Accordingly, FIG. 2B illustrates the first object 202 positioned in the first sub-region 108 and cut from the canvas region 104. The user may later paste the first object back into the canvas region 108 by moving the first object to a sub-region associated with paste functionality, providing a menu command selection, or the like. FIG. 2C illustrates a movement of the second object 204 to the second sub-region 110. As an example, the second sub-region 110 may indicate a delete operation. Accordingly, FIG. 2D illustrates the second object being deleted from both the canvas region and the drop zone region. Further, FIG. 2E illustrates an example of the first object 202 and the second object 204 being merged. For instance, the third sub-region 112 may be associated with a merge operation. Accordingly, the user may position the first object 202 and the second object 204 in the third sub-region 112 to merge both objects into a single object. For example, the resulting object is a combination of a circle and an ellipse.

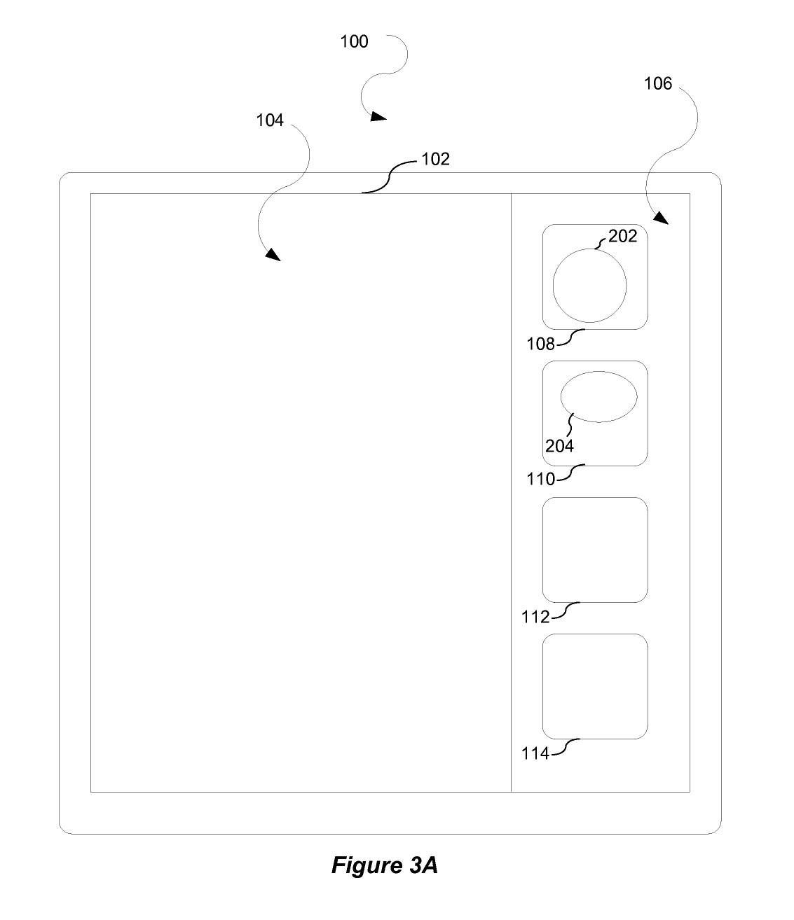

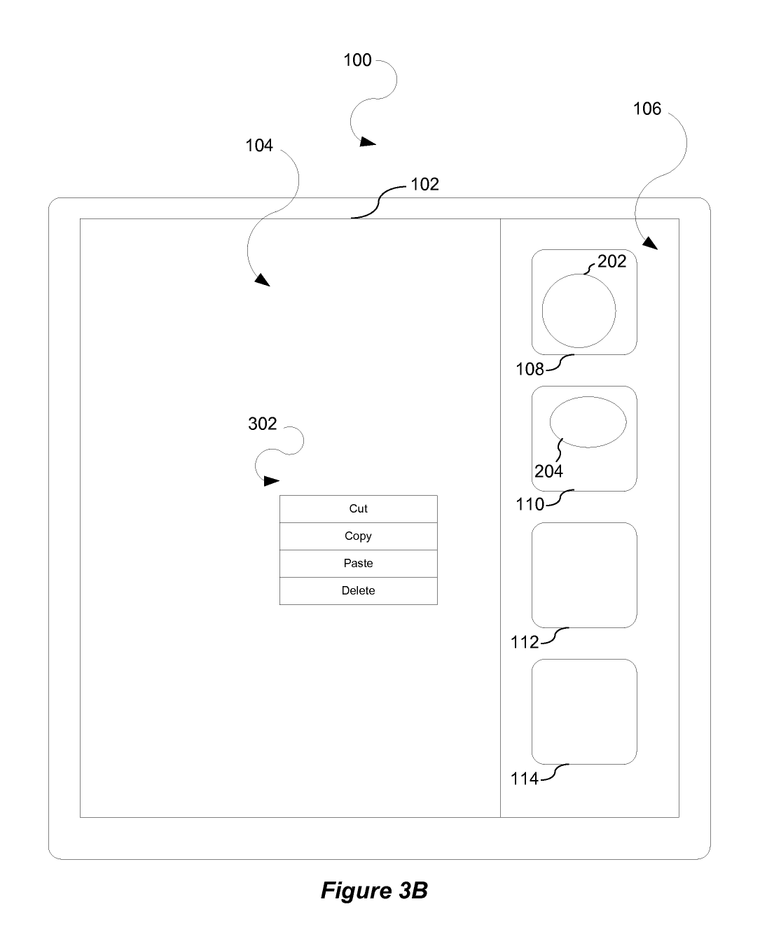

FIGS. 3A and 3B illustrate an example of a first object 202 and a second object 204 such that the sub-regions of the drop zone region 106 do not each have an associated functionality. FIG. 3A illustrates an example of the first object 202 being positioned in the first sub-region 108 and the second object 204 being positioned in the second sub-region 110. As functionality is not associated with individual sub-regions in this configuration, the objects may be positioned in any of the sub-regions. FIG. 3B illustrates an example of a drop zone menu 302 that may be utilized to perform an operation on the contents of the drop zone or a portion of the contents of the drop zone. For instance, the drop zone menu 302 may include operations such as cut, copy, pate, delete, or the like. The user may select an operation that will be applied to all of the objects in the drop zone region 106. For instance, the user may perform a cut operation on the drop zone region 106, which would cut all of the contents in the drop zone region 106, e.g., the first object 202 in the first sub-region 108 and the second object 204 in the second sub-region 110. The drop zone menu 302 may be displayed anywhere in the touch enabled device GUI 102. Accordingly, the drop zone menu may be displayed in the canvas region 104, the drop zone region 106, outside either or both of the canvas region 104 and the drop zone region 106, or the like.

In one embodiment, the size of the drop zone region 106 may be expanded. Accordingly, a user may scale the objects in the drop zone region 106 by changing the size of the drop zone region 106. Further, in another embodiment, the size of the canvas region 104 may be adjusted. In another embodiment, a one or more toolbars may be utilized to provide additional functionality such as particular operations to be performed on one or more objects within the drop zone region 106. For example, a drawing toolbar may be utilized to provide features such as color, opacity, or the like.

In another embodiment, the canvas region 104 may be changed while the drop zone region 106 is changed. For example, a user may cut an object from a page displayed in the canvas region 104, flip to a different page in the canvas region 104, and paste the object from the drop zone region 106 into the new page. As an example, the pages may be from a digital magazine, word processing document, website, or the like. Further, the content itself may change in the canvas region 104 while the drop zone region 106 may be constant. For example, a user may move a page of a digital magazine from the canvas region 104 and position it in the drop zone region 106. The user may then switch the content in the canvas region 104 to display a word processing document, but the drop zone region 106 remains constant to include the page from the digital magazine. The user may then also move a page from the word processing document to the drop zone region 106. Further, the user may then perform batch processing on the drop zone region 106 to perform an operation on all of the objects in the drop zone region 106 or a portion of the drop zone region 106 such as the page from the digital magazine and the page from the word processing document.

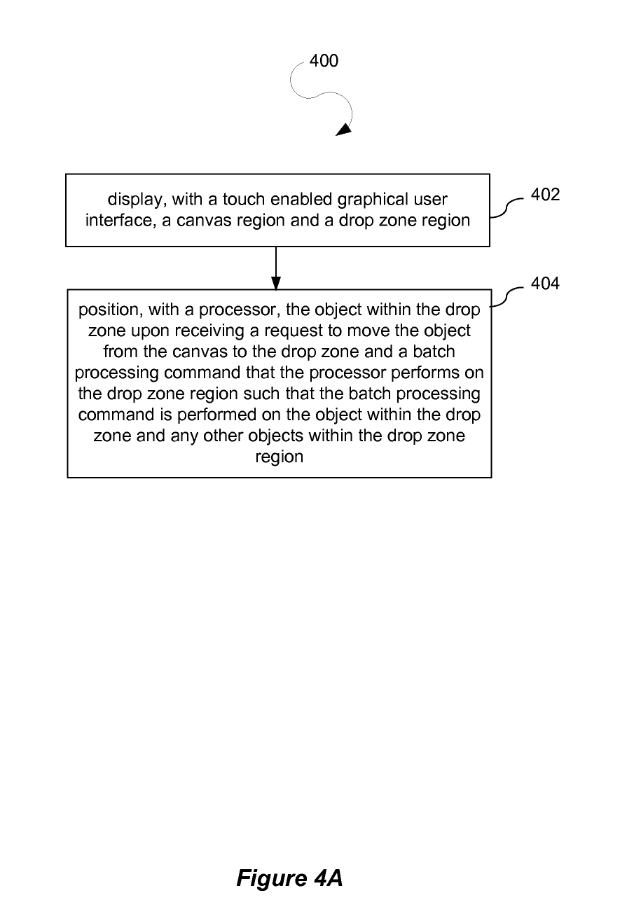

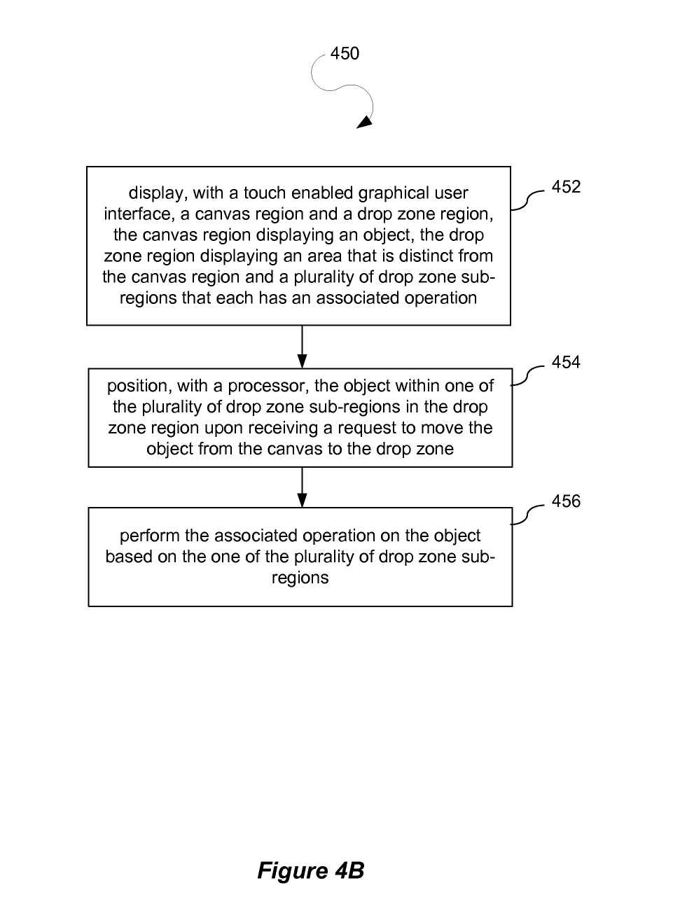

FIG. 4A illustrates a process 400 that provides a drop zone region with batch processing. At a process block 402, the process 400 displays, with a touch enabled graphical user interface, a canvas region and a drop zone region. The canvas region displays an object. The drop zone region displays an area that is distinct from the canvas region. Further, at a process block 404, the process 400 positions, with a processor, the object within the drop zone upon receiving a request to move the object from the canvas to the drop zone and a batch processing command that the processor performs on the drop zone region such that the batch processing command is performed on the object within the drop zone and any other objects within the drop zone region.

FIG. 4B illustrates a process 450 that is utilized to provide sub-region functionality in a drop zone. At a process block 452, the process 450 displays, with a touch enabled graphical user interface, a canvas region and a drop zone region. The canvas region displays an object. The drop zone region displays an area that is distinct from the canvas region and a plurality of drop zone sub-regions that each has an associated operation. Further, the process 450 positions, with a processor, the object within one of the plurality of drop zone sub-regions in the drop zone region upon receiving a request to move the object from the canvas to the drop zone. In addition, the process performs the associated operation on the object based on the one of the plurality of drop zone sub-regions.

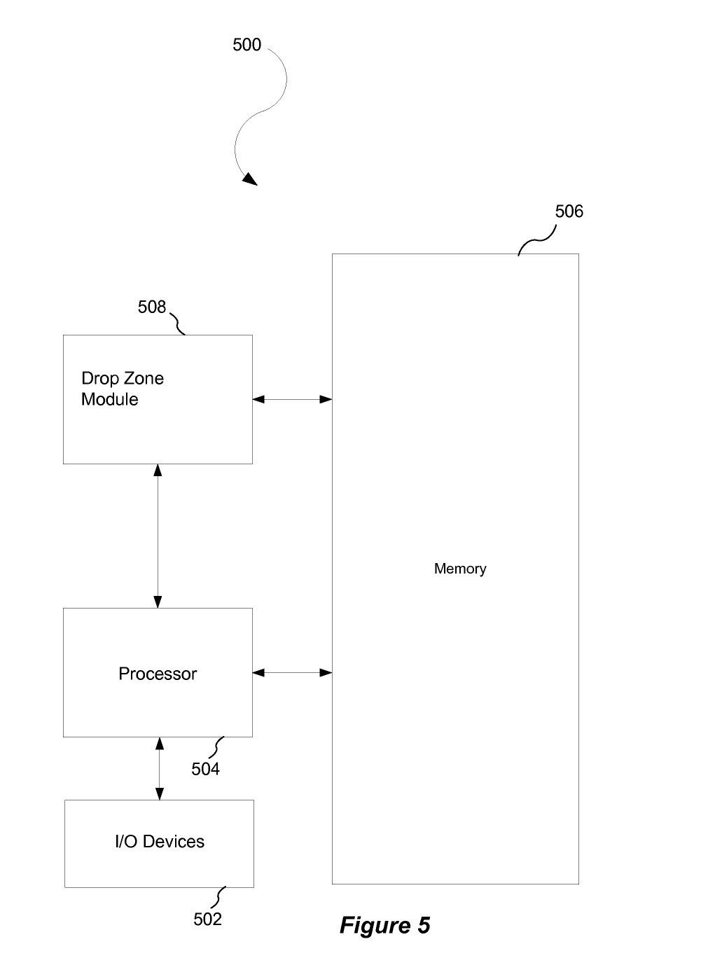

FIG. 5 illustrates a system configuration 500 that may be utilized to provide a drop zone region. In one embodiment, a drop zone module 508 interacts with a memory 506 to render a drop zone region in a touch enabled device GUI. In one embodiment, the system configuration 500 is suitable for storing and/or executing program code and is implemented using a general purpose computer or any other hardware equivalents. The processor 504 is coupled, either directly or indirectly, to the memory 506 through a system bus. The memory 506 can include local memory employed during actual execution of the program code, bulk storage, and/or cache memories which provide temporary storage of at least some program code in order to reduce the number of times code must be retrieved from bulk storage during execution.

The Input/Output (“I/O”) devices 502 can be coupled directly to the system configuration 500 or through intervening input/output controllers. Further, the I/O devices 502 may include a keyboard, a keypad, a mouse, a microphone for capturing speech commands, a pointing device, and other user input devices that will be recognized by one of ordinary skill in the art. Further, the I/O devices 502 may include output devices such as a printer, display screen, or the like. Further, the I/O devices 502 may include a receiver, transmitter, speaker, display, image capture sensor, biometric sensor, etc. In addition, the I/O devices 502 may include storage devices such as a tape drive, floppy drive, hard disk drive, compact disk (“CD”) drive, etc.

Network adapters may also be coupled to the system configuration 500 to enable the system configuration 500 to become coupled to other systems, remote printers, or storage devices through intervening private or public networks. Modems, cable modems, and Ethernet cards are just a few of the currently available types of network adapters.

The processes described herein may be implemented in a general, multi-purpose or single purpose processor. Such a processor will execute instructions, either at the assembly, compiled or machine-level, to perform the processes. Those instructions can be written by one of ordinary skill in the art following the description of the figures corresponding to the processes and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized data through wireline or wireless transmissions locally or remotely through a network. A computer is herein intended to include any device that has a general, multi-purpose or single purpose processor as described above.

It should be understood that the computer program products, processes, and systems described herein can take the form of entirely hardware embodiments, entirely software embodiments, or embodiments containing both hardware and software elements. If software is utilized to implement the method or system, the software can include but is not limited to firmware, resident software, microcode, etc.

It is understood that the computer program products, processes, and systems described herein may also be applied in other types of processes and systems. Those skilled in the art will appreciate that the various adaptations and modifications of the embodiments of the processes and systems described herein may be configured without departing from the scope and spirit of the present processes, systems, and computer program products. Therefore, it is to be understood that, within the scope of the appended claims, the present processes, systems, and computer program products may be practiced other than as specifically described herein.

I claim:

1. A touch enabled device comprising:
a touch enabled graphical user interface that displays a canvas region and a drop zone region, the canvas region displaying an object, the drop zone region displaying an area that is distinct from the canvas region; and
a processor that positions the object within the drop zone upon receiving a request to move the object from the canvas to the drop zone and a batch processing command that the processor performs on the drop zone region such that the batch processing command is performed on the object within the drop zone and any other objects within the drop zone region.

2. The touch enabled device of claim 1, wherein the drop zone region displays the object and the any other objects irrespective of the canvas region displaying a first set of content and subsequently displaying a second set of content that is distinct from the first set of content.

3. The touch enabled device of claim 1, wherein the batch processing command is selected from the group consisting of a cut operation, a copy operation, and a paste operation.

4. The touch enabled device of claim 1, wherein the batch processing command is an operation that combines the object with an additional object in the drop zone.

5. The touch enabled device of claim 4, wherein the request moves the object to the drop zone over the additional object.

6. The touch enabled device of claim 1, wherein the request is a drag and drop input.

7. The touch enabled device of claim 1, wherein the batch processing command is a tap selection from a contextual menu.

8. The touch enabled device of claim 1, wherein the drop zone region is revealed by an input.

9. The touch enabled device of claim 1, wherein the drop zone region is contextual.

10. A computer program product comprising a computer useable medium having a computer readable program, wherein the computer readable program when executed on a computer causes the computer to:
display, with a touch enabled graphical user interface, a canvas region and a drop zone region, the canvas region displaying an object, the drop zone region displaying an area that is distinct from the canvas region, the drop zone region displaying the object and any other objects within the drop zone region irrespective of the canvas region displaying a first set of content and subsequently displaying a second set of content that is distinct from the first set of content; and
position, with a processor, the object within the drop zone upon receiving a request to move the object from the canvas to the drop zone and a batch processing command that the processor performs on the drop zone region such that the batch processing command is performed on the object within the drop zone and the any other objects within the drop zone region.

11. The computer program product of claim 10, wherein the first set of content is a first page of a digital magazine and the second set of content is a second page of a digital magazine.

12. The computer program product of claim 10, wherein the batch processing command is selected from the group consisting of a cut operation, a copy operation, and a paste operation.

13. The computer program product of claim 10, wherein the batch processing command is an operation that combines the object with an additional object in the drop zone.

14. The computer program product of claim 13, wherein the request moves the object to the drop zone over the additional object.

15. A method comprising:
displaying, with a touch enabled graphical user interface, a canvas region and a drop zone region, the canvas region displaying an object, the drop zone region displaying an area that is distinct from the canvas region and a plurality of drop zone sub-regions that each has an associated operation;
positioning, with a processor, the object within one of the plurality of drop zone sub-regions in the drop zone region upon receiving a request to move the object from the canvas to the drop zone; and
performing the associated operation on the object based on the one of the plurality of drop zone sub-regions.

16. The method of claim 15, wherein the command is performed on the object within the drop zone region and any other objects within the drop zone region.

17. The method of claim 15, wherein the associated operation is selected from the group consisting of a cut operation, a copy operation, and a paste operation.

18. The method of claim 15, wherein the associated operation is an operation that combines the object with an additional object in the drop zone.

19. The method of claim 18, wherein the request moves the object to the drop zone over the additional object.

20. The method of claim 15, wherein the request is a drag and drop input.
